(19) United States
(12) Patent Application Publication
(10) Pub. No.: US 2006/0199067 A1
(43) Pub. Date: Sep. 7, 2006

(54) Compression Devices and Electrochemical Cell Stack Design

(75) Inventors: Frano Barbir, Rocky Hill, CT (US); Robert H. Byron JR., Lebanon, CT (US); Matt Stone, Rocky Hill, CT (US); Bhaskar Balasubramanian, MIddletown, CT (US)

Correspondence Address: CANTOR COLBURN, LLP - PROTON, 55 GRIFFIN ROAD SOUTH, BLOOMFIELD, CT, 06002, US

(73) Assignee: PROTON ENERGY SYSTEMS, INC., Wallingford, CT (US)

(21) Appl. No.: 11/419,057

(22) Filed: May 18, 2006

Related U.S. Application Data
(62) Division of application No. 10/202,701, filed on Jul. 25, 2002, now abandoned.

(51) Int. Cl. H01M 8/02

(52) U.S. Cl. 429/37; 429/38

(57) ABSTRACT

In one embodiment a compression device comprises: a base plate having a surface, a spring support plate, a resilient member, a manifold, and a side plate. The resilient member is disposed between the spring support plate and the base plate in compressible mechanical communication with the base plate to enable a force to be imparted to the base plate in a direction normal to the surface. The side plate is disposed from the spring support plate to the manifold, wherein the side plate physically engages a periphery of the manifold and a periphery of the spring support plate.

### CROSS-REFERENCE TO RELATED APPLICATIONS

This application is a divisional application of U.S. patent application Ser. No. 10/202,701 filed Jul. 25, 2002, the contents of which are incorporated by reference herein in their entirety.

### BACKGROUND

This disclosure relates to electrochemical cell systems, and, more particularly, to a design for an electrochemical cell stack in which the flow fields of the stack extend longitudinally between the end plates of the stack and include bipolar plates maintained in compression by side plates. The disclosure furthermore particularly relates to a design in which internally-generated water and heat are utilized for internal humidification of a supplied oxidant and in which heaters are disposed between the bipolar plates to maintain the cell stack at a temperature that minimizes the warm-up time.

Electrochemical cells are energy conversion devices, usually classified as either electrolysis cells or fuel cells. Proton exchange membrane electrolysis cells can function as hydrogen generators by electrolytically decomposing water to produce hydrogen and oxygen gases. Referring to FIG. 1, a section of an anode feed electrolysis cell of the prior art is shown generally at 10 and is hereinafter referred to as “cell 10.” Reactant water 12 is fed into cell 10 at an oxygen electrode (anode) 14 to form oxygen gas 16, electrons, and hydrogen ions (protons) 15. The chemical reaction is facilitated by the positive terminal of a power source 18 connected to anode 14 and the negative terminal of power source 18 connected to a hydrogen electrode (cathode) 20. Oxygen gas 16 and a first portion 22 of the water are discharged from cell 10, while protons 15 and a second portion 24 of the water migrate across a proton exchange membrane 26 to cathode 20. At cathode 20, hydrogen gas 28 is removed, generally through a gas delivery line. The removed hydrogen gas 28 is usable in a myriad of different applications. Second portion 24 of water is also removed from cathode 20.

An electrolysis cell system may include a number of individual cells arranged in a stack with reactant water being directed through the cells via input and output conduits formed within the stack structure. The cells within the stack are sequentially arranged, and each one includes a membrane electrode assembly (MEA) defined by a proton exchange membrane disposed between a cathode and an anode. The cathode, anode, or both may be gas diffusion electrodes that facilitate gas diffusion to the proton exchange membrane. Each membrane electrode assembly is in fluid communication with flow fields adjacent to the membrane electrode assembly, defined by structures configured to facilitate fluid movement and membrane hydration within each individual cell.

The portion of water discharged from the cathode side of the cell, which is entrained with hydrogen gas, is fed to a phase separator to separate the hydrogen gas from the water, thereby increasing the hydrogen gas yield and the overall efficiency of the cell in general. The removed hydrogen gas may be fed either to a dryer for removal of trace water, to a storage facility, e.g., a cylinder, a tank, or a similar type of containment vessel, or directly to an application for use as a fuel.

Another type of water electrolysis cell that utilizes the same configuration as is shown in FIG. 1 is a cathode feed cell. In the cathode feed cell, process water is fed on the side of the hydrogen electrode. A portion of the water migrates from the cathode across the membrane to the anode. A power source connected across the anode and the cathode facilitates a chemical reaction that generates hydrogen ions and oxygen gas. Excess process water exits the cell at the cathode side without passing through the membrane.

A typical fuel cell also utilizes the same general configuration as is shown in FIG. 1. Hydrogen gas is introduced to the hydrogen electrode (the anode in the fuel cell), while oxygen, or an oxygen-containing gas such as air, is introduced to the oxygen electrode (the cathode in the fuel cell). The hydrogen gas for fuel cell operation can originate from a pure hydrogen source, a hydrocarbon, methanol, or any other source that supplies hydrogen at a purity level suitable for fuel cell operation. Hydrogen gas electrochemically reacts at the anode to produce protons and electrons, the electrons flow from the anode through an electrically connected external load, and the protons migrate through the membrane to the cathode. At the cathode, the protons and electrons react with oxygen to form water.

Conventional electrochemical cell systems generally include one or more individual cells arranged in a stack, with the working fluids directed through the cells via input and output conduits formed within the stack structure. A typical fuel cell system that can be utilized with other cells and incorporated into a stack structure is shown at 30 with reference to FIG. 2. Cell system 30 comprises an MEA defined by a proton exchange membrane 32 having a first electrode (e.g., an anode) 34 and a second electrode (e.g., a cathode) 36 disposed on opposing sides thereof. Regions proximate to and bounded on at least one side by anode 34 and cathode 36 respectively define flow fields 38, 40. On the anode side of the MEA, a flow field support member 42 may be disposed adjacent to anode 34 to facilitate membrane hydration and/or fluid movement to the membrane. Flow field support member 42 is retained within flow field 38 by a frame 44 and a cell separator plate 48. A gasket 46 is optionally positioned between frame 44 and cell separator plate 48 to effectively seal flow field 38. On the cathode side of the MEA, a flow field support member 50 may be disposed adjacent to cathode 36 to further facilitate membrane hydration and/or fluid movement to the membrane.

A pressure pad 52 is typically disposed between flow field support member 50 and a cell separator plate 54. A pressure pad separator plate 62 may be disposed between flow field support member 50 and pressure pad 52. Pressure pads may be disposed on either or both sides of membrane 32 and may be positioned within either or both of the flow fields of cell system 30 in place of either or both of the flow field support members. One or more pressure plates 60 may optionally be disposed adjacent to pressure pad 52 to distribute the pressure exerted on pressure pad 52 and increase the pressure within the cell environment. Flow field support member 50 and pressure pad 52 (as well as optional pressure plates 60) are retained within flow field 40 by a frame 56 and cell separator plate 54. A gasket 58 is optionally positioned between frame 56 and cell separator plate 54 to effectively seal flow field 40. The cell components, particularly frames 44, 56, cell separator plates 48, 54, and gaskets 46, 58, are formed with the suitable manifolds or other conduits to facilitate fluid communication through cell system 30.

Heat generated at each cell during the operation of an electrochemical cell system is generally dissipated via “cooler plates” positioned at various locations in the electrochemical stack. The cooler plates generally comprise metal flow tubes arranged in serpentine configurations. The tubes are also typically embedded within a plate structure. A coolant is made to flow through the flow tubes to absorb the heat produced by the reaction of the reactant chemicals. The flow rate of the coolant stream may be adjusted to provide for the controlled removal of heat from the system. While in most systems the coolant of choice is a liquid, some systems utilize reactant oxygen as the coolant.

Electrochemical cell systems such as that shown in FIG. 2, as well as others of similar constructions, are generally maintained in compression by tie rods, springs, or hydraulic pistons. The springs may be twisted wire springs or ribbon springs that extend between the plates of the cell system to urge the plates together to retain the membrane electrode assemblies. Other devices for maintaining the compression of the cell system include compression bands that circumscribe the plates of the system and the interposed cell assemblies of the stack.

Most cell systems operate more efficiently when wet. In order to wet the relevant parts of the cells, the reactant gases may be humidified via liquid water injected into a flow channel of a fluid flow plate of a cell assembly. In the humidification of the reactant gases, however, significant amounts of heat may be required to saturate the gases at a temperature close to the operating temperature of the fuel cell. Furthermore, temperature variations within the reactant gas manifolds and plate channels can lead to condensation of the vapor and poor distribution of the reactant gases. Pockets of condensate may accumulate within the plate channels, thereby inhibiting the free flow of the reactant gases. Moreover, because the vapor distribution is unpredictable, drying of the membrane may occur despite the introduction of water vapor into the gas streams at the inlet of the fluid manifold.

If the cell system forms part of a back-up power application, rapid startup of the system is generally desired in order to minimize or eliminate any discontinuities in power generation. Because the startup of a cell is a function of its temperature, the cell is generally maintained at or near the operating temperature of the cell even when the cell is non-operational. In order to maintain the cell at such a temperature, a return coolant stream from the electrolysis unit of the cell stack may be directed through or around the cell stack to transfer heat removed from the electrolysis unit to the cell stack. However, because there may be periods of time when both the electrolysis unit and the fuel cell are idle, maintaining the cell stack at a temperature sufficient for rapid startup of the system may not be possible with the return coolant stream.

While existing electrolysis cell systems are suitable for their intended purposes, there still remains a need for improvements. Some of the improvements needed include apparatuses and methods of effectively dissipating heat from the cell stack and, in particular, allowing for the maximum dissipation of heat from the edges of the cell stack, maintaining the cell stack components in compression, internally humidifying the reactant gases, and maintaining the cell stack at a temperature that minimizes the warm-up time of the cell system.

### BRIEF SUMMARY

Disclosed herein are compression devices, electrochemical cell devices, and methods for using the same. In one embodiment a compression device comprises: a base plate having a surface, a spring support plate, a resilient member, a manifold, and a side plate. The resilient member is disposed between the spring support plate and the base plate in compressible mechanical communication with the base plate to enable a force to be imparted to the base plate in a direction normal to the surface. The side plate is disposed from the spring support plate to the manifold, wherein the side plate physically engages a periphery of the manifold and a periphery of the spring support plate.

In one embodiment, an electrochemical cell device comprises: a cell stack comprising cells and a compression device. Each cell comprises a first electrode and a second electrode with a membrane disposed therebetween. The compression device comprises a base plate having a surface, a spring support plate, a resilient member, a manifold, and a side plate. The resilient member is disposed between the spring support plate and the base plate in compressible mechanical communication with the base plate to enable a force to be imparted to the base plate in a direction normal to the surface. The side plate is disposed from the spring support plate to the manifold, wherein the side plate physically engages a periphery of the manifold and a periphery of the spring support plate.

In another embodiment, an electrochemical cell device comprises: a cell stack, a base plate disposed at the cell stack, a spring support plate disposed on a side of the base plate opposite the cell stack, a resilient member disposed between the spring support plate and the base plate in compressible mechanical communication with the base plate, a manifold disposed on a side of the cell stack opposite the base plate, and side plates disposed from the spring support plate to the manifold. The manifold has manifold tabs disposed at a periphery of the manifold and is disposed in a parallel planar relationship with the spring support plate. The side plates engage the manifold tabs and the support tabs. The cell stack is compressed between the base plate and the manifold by compressive force applied by the resilient member in a direction normal to a plane defined by a length and a width of the base plate.

The above discussed and other features will be appreciated and understood by those skilled in the art from the following detailed description and drawings.

### BRIEF DESCRIPTION OF THE DRAWINGS

Referring now to the drawings wherein like elements are numbered alike in several Figures:

FIG. 1 is a schematic representation of an anode feed electrolysis cell of the prior art;

FIG. 2 is a schematic representation of a cell system of the prior art;

FIG. 3 is an exploded perspective view of a cell stack;

FIG. 4 is a plan view of an MEA;

FIG. 5 is a plan view of a cathode face of a bipolar plate;

FIG. 6 is a cross sectional view of a bipolar plate;

FIG. 7 is a sectional view of an atomizer;

FIG. 8 is a perspective view of an atomizer that functions as an alignment pin; and

FIG. 9 is a perspective view of a heating element disposed on a bipolar plate.

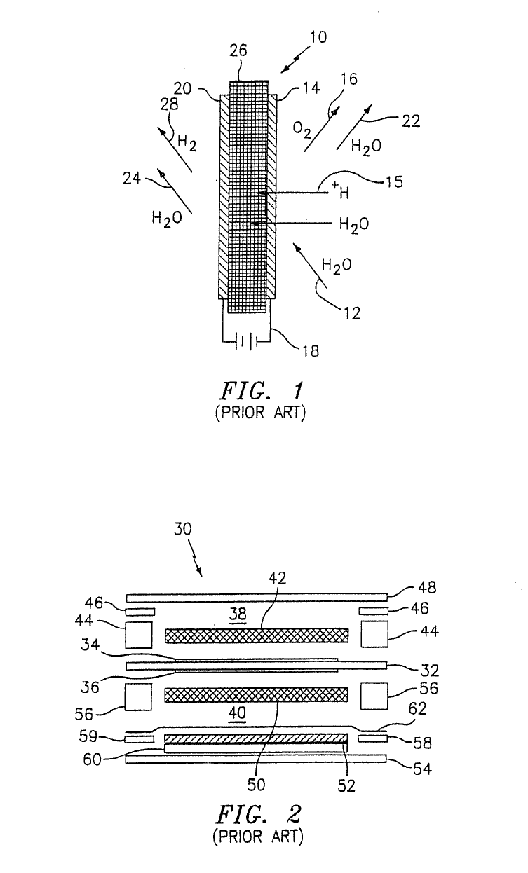

### DETAILED DESCRIPTION

Disclosed herein is an electrochemical cell that may be operated as either a fuel cell or an electrolysis cell. Also disclosed are methods for operating the electrochemical cell. While the discussion below is directed to a fuel cell, it should be understood that anode feed electrolysis cells, cathode feed electrolysis cells, and regenerative fuel cells are also within the scope of the embodiments disclosed.

A cell stack is formed of a plurality of individual cells and includes flow field support members that are preferably in the form of bipolar plates. The plates are elongated and maintained in compression by being urged together in a direction normal to the face of the plate at the top of the stack. The flow regions disposed on the faces of each plate comprise channels that extend in the lengthwise dimension between openings at opposing ends of the plates. Heat is generally dissipated from each plate via fins that extend along the edges thereof. A coolant (e.g., air) is preferably made to flow along the fins to effect the removal of the heat. By-product liquid (e.g., water in a fuel cell that employs hydrogen and oxygen gases as the reactants) is recycled within the cell stack and utilized to humidify at least one of the inlet reactant gases. In order to minimize startup up time of the cell subsequent to prolonged periods of downtime in a cold environment, heaters are preferably disposed intermediate the plates to maintain the temperature of the cell at or near its typical operating temperature.

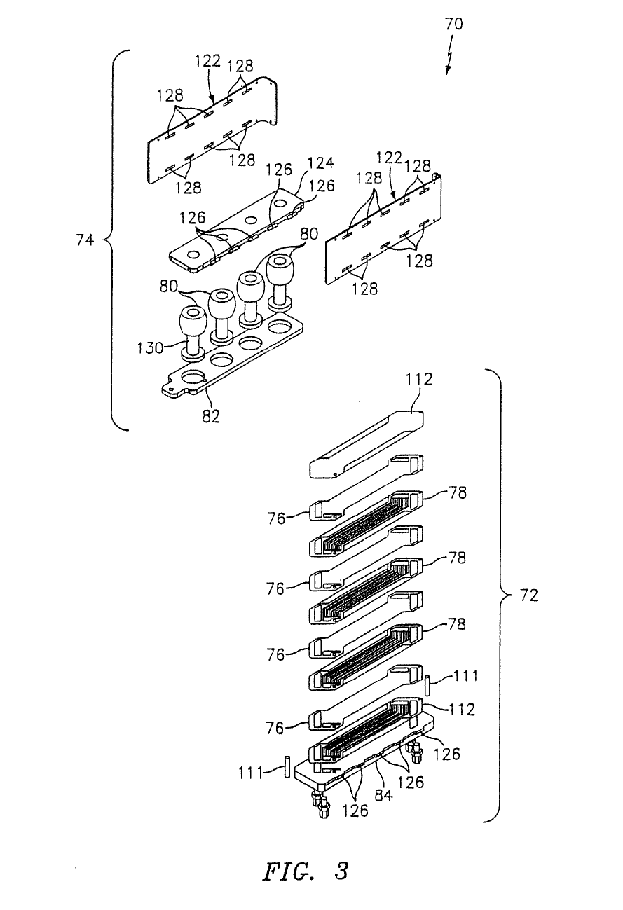

Referring to FIG. 3, one exemplary embodiment of an electrochemical cell stack is shown at 70 and is hereinafter referred to as “cell stack 70.” Cell stack 70 typically includes a plurality of cells employed as part of the cell system. When cell stack 70 is utilized as a fuel cell, power outputs are dependent upon the number of cells. Typically, the outputs are about 0.4 volts to about 1 volt, with current densities being about 0.1 A/ft² (amperes per square foot) to about 10,000 A/ft². When used as an electrolysis cell, voltage inputs are generally 1.48 volts to about 3.0 volts, with current densities of about 50 A/ft² to about 4,000 A/ft². Current densities exceeding 10,000 A/ft² may also be obtained depending upon the fuel cell dimensions and configuration. The number of cells within the stack and the dimensions of the individual cells is scalable to the cell power output and/or gas output requirements.

Cell stack 70 comprises a plurality of cells 72 and a compression device 74 configured to maintain plurality of cells 72 in compression with each other. The cells are maintained in alignment with each other via alignment pins 111. Each cell comprises an MEA 76 defined by a proton exchange membrane having electrodes (an anode and a cathode) disposed at opposing sides thereof. Flow field support members are disposed between each MEA 76. The flow field support members are typically bipolar plates 78 having channeled surfaces formed in the opposing sides of each plate. Bipolar plates 78 are generally fabricated of carbon composite materials, e.g., about 70% to about 90% graphite and about 10% to about 30% plastic, wherein the plastic may be a polypropylene, a polyethylene, a polyvinylester, a phenolic, polyvinylidene difluoride, combinations of the foregoing materials, and the like. Other types of flow field support members, for example, screen packs, may be utilized. Compression device 74 comprises one or more resilient members 80 configured to urge a plate (e.g., a base plate 82) against the MEA/bipolar plate assemblies and against a support plate (e.g., a manifold 84).

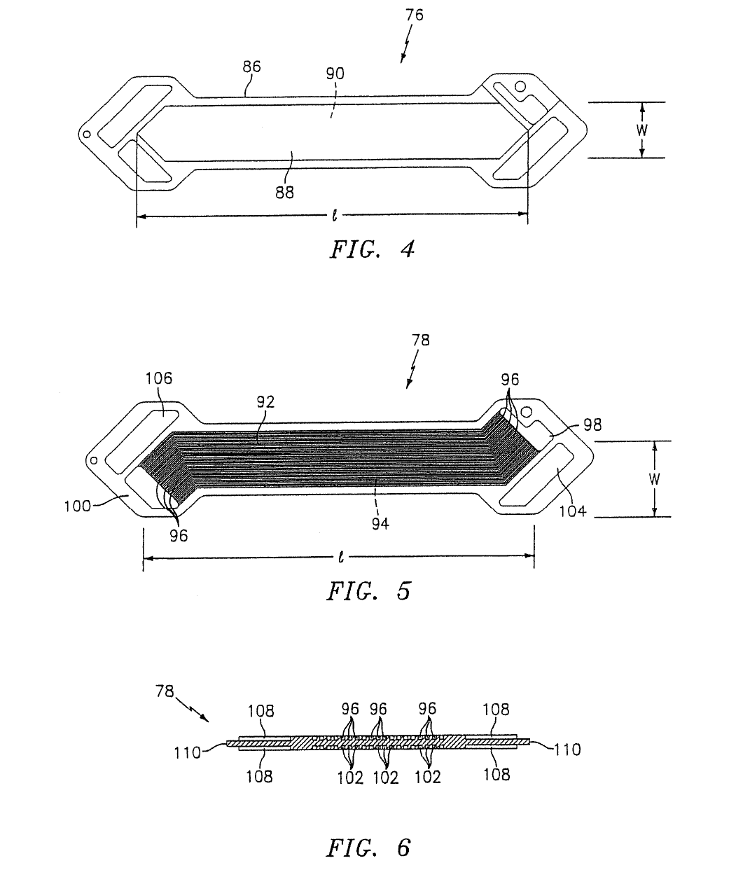

Referring to FIG. 4, MEA 76 is shown. MEA 76 comprises a proton exchange membrane 86 and the electrodes (anode 88 and cathode 90) disposed at opposing sides of proton exchange membrane 86. Both anode 88 and cathode 90 are positioned on the surface of proton exchange membrane 86 within the active areas, which are defined as the areas of a fuel cell at which the chemical reaction of hydrogen and oxygen take place to produce the desired flow of electrons and the by-product water. As shown, the active areas of MEA 76 are substantially longer in a dimension l than they are wide in a dimension w to define a cell of the improved configuration. The amount that MEA 76 is longer than wide is such that a temperature differential measured across the shortest distance from the center of the active area of MEA 76 to the edge of the active area of MEA 76 is less than about 15° C., and more preferably less than about 10° C. In particular, the length to width ratio of the active areas of MEA 76 (and thus each cell of the cell system) is preferably greater than or equal to about 4:1.

Membrane 86 comprises electrolytes that are preferably solids under the operating conditions of the electrochemical cell. Useful materials from which membrane 86 can be fabricated include proton conducting ionomers and ion exchange resins. Useful proton conducting ionomers include complexes comprising an alkali metal salt, an alkali earth metal salt, a protonic acid, a protonic acid salt, or the like, as well as combinations of the foregoing materials. Counter-ions useful in the above salts include halogen ion, perchloric ion, thiocyanate ion, trifluoromethane sulfonic ion, borofluoric ion, and the like, as well as combinations of the foregoing materials. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, and the like, as well as combinations of the foregoing materials. The alkali metal salt, alkali earth metal salt, protonic acid, or protonic acid salt is complexed with one or more polar polymers such as a polyether, polyester, or polyimide, or with a network or cross-linked polymer containing the above polar polymer or combination of polymers as a segment. Useful polyethers include polyoxyalkylenes, such as polyethylene glycol, polyethylene glycol monoether, and polyethylene glycol diether; copolymers of at least one of these polyethers, such as poly(oxyethylene-co-oxypropylene) glycol, poly(oxyethylene-co-oxypropylene) glycol monoether, and poly(oxyethylene-co-oxypropylene) glycol diether; condensation products of ethylenediamine with the above polyoxyalkylenes; and esters, such as phosphoric acid esters, aliphatic carboxylic acid esters or aromatic carboxylic acid esters of the above polyoxyalkylenes. Copolymers of, e.g., polyethylene glycol with dialkylsiloxanes, maleic anhydride, or polyethylene glycol mono ethyl ether with methacrylic acid, are known in the art to exhibit sufficient ionic conductivity to be useful.

Ion-exchange resins useful as proton conducting materials include hydrocarbon- and fluorocarbon-type resins. Hydrocarbon-type ion-exchange resins include phenolic resins, condensation resins such as phenol-formaldehyde, polystyrene, styrene-divinyl benzene copolymers, styrene-butadiene copolymers, styrene-divinylbenzene-vinylchloride terpolymers, and the like, that are imbued with cation-exchange ability by sulfonation, or are imbued with anion-exchange ability by chloromethylation followed by conversion to the corresponding quaternary amine.

Fluorocarbon-type ion-exchange resins can include hydrates of tetrafluoroethylene-perfluorosulfonyl ethoxyvinyl ether or tetrafluoroethylene-hydroxylated (perfluoro vinyl ether) copolymers. When oxidation and/or acid resistance is desirable, for instance, at the cathode of a fuel cell, fluorocarbon-type resins having sulfonic, carboxylic and/or phosphoric acid functionality are preferred. Fluorocarbon-type resins typically exhibit excellent resistance to oxidation by halogen, strong acids, and bases. One family of fluorocarbon-type resins having sulfonic acid group functionality is a perfluorinated sulfonyl fluoride polymer such as NAFION® resins (commercially available from E. I. du Pont de Nemours and Company, Wilmington, Del.).

Anode 88 and cathode 90 are fabricated from catalyst materials suitable for performing the needed electrochemical reaction (i.e., electrolyzing water to produce hydrogen and oxygen). Suitable materials for anode 88 and cathode 90 include, but are not limited to, platinum, palladium, rhodium, carbon, gold, tantalum, tungsten, ruthenium, iridium, osmium, alloys thereof, and the like, as well as combinations of the foregoing materials. Anode 88 and cathode 90 may be adhesively disposed on membrane 86, or they may be positioned adjacent to, but in contact with, membrane 86.

Referring now to FIG. 5, a bipolar plate 78 is shown. Bipolar plate 78 is preferably substantially longer in a dimension l than it is wide in a dimension w to correspond with an adjacently-positioned MEA. Preferably the length to width ratio of bipolar plate 78 corresponds to the length to width ratio of the MEA and is greater than or equal to about 4:1.

Bipolar plate 78 is also preferably electrically conductive and disposable at each electrode to facilitate the distribution of the reactant gases to their respective electrodes and the hydration of the MEA. Materials from which bipolar plate 78 can be fabricated commonly include metals, carbon, or carbon composite structures incorporating a polymeric binder. Typical metals that may be used to fabricate bipolar plates include, but are not limited to, niobium, zirconium, tantalum, titanium, carbon steel, stainless steel, nickel, cobalt, and the like, as well as alloys and combinations of the foregoing materials. In alternate embodiments of the cell system, screen packs (not shown) may be utilized in place of either or both bipolar plates in a cell. Screen packs include one or more layers of perforated sheets or a woven mesh formed from metal strands. Typical metals that may be used to fabricate screen packs include, but are not limited to, niobium, zirconium, tantalum, titanium, carbon steel, stainless steel, nickel, cobalt, and the like, as well as alloys and combinations of the foregoing materials.

A flow region 92 on a cathode face of bipolar plate 78 is dimensioned to align with the active area (i.e., the cathode) of the adjacently-positioned MEA. When the cell is utilized as a fuel cell, flow region 92 provides for the flow of oxygen to the oxygen side of the MEA and comprises a plurality of channels 96 cut or otherwise formed in the surface of bipolar plate 78 to define pathways by which oxygen can be introduced to the MEA. Flow region 92 further provides for the removal of water from the cathode, which removes latent heat from the cell. Channels 96 extend between openings 98, 100 at opposing ends of bipolar plate 78. Because of the dimensions of bipolar plate 78 and the positioning of openings 98, 100, channels 96 extend substantially linearly between openings 98, 100 to effect the substantially unimpeded flow of oxygen to each bipolar plate 78. When a plurality of bipolar plates 78 and MEAs are stacked to form the cell system, openings 98, 100 form a manifold through which oxygen is simultaneously introduced to each bipolar plate 78 and the cathode side of each MEA and through which water is removed from each cathode.

A flow region (not shown) disposed on the anode face of bipolar plate 78 is configured to be similar to flow region 92 and, when bipolar plate 78 is incorporated into a fuel cell, provides for the flow of hydrogen gas to the anode side of each MEA. The flow region comprises a plurality of channels (not shown) that extend between openings 104, 106 at opposing ends of bipolar plate 78. As with channels 96 on the cathode side of bipolar plate 78, the channels extend substantially linearly between openings 104, 106 to effect the substantially unimpeded flow of hydrogen to the anode sides of each bipolar plate 78. When a plurality of bipolar plates 78 and MEAs are stacked to form the cell system, openings 104, 106 form a manifold through which hydrogen is simultaneously introduced to each bipolar plate 78 and each MEA.

Operation of a cell stack into which bipolar plate 78 is incorporated is preferably such that air and hydrogen enter the cell at the same end of bipolar plate 78. In a vertically-oriented cell stack, bipolar plate 78 is arranged such that the openings at one end are at a lower elevation than the openings at the opposing end. Air and hydrogen are fed to the openings at the lower end such that the flow of air through the channels at one side of bipolar plate 78 is co-current with the flow of hydrogen through the channels at the opposing side of bipolar plate 78. The gases may also be fed to the openings at the upper end of bipolar plate 78 for co-current flow or to both ends for counter-current flow. In either configuration, the flow of air and hydrogen vertically through the channels provides a flow path with no laterally-oriented legs, thereby allowing for the mass transport of water though the cell due to pressure of the gas in the channels as well as gravity.

In a horizontally-oriented cell stack, on the other hand, water is transported through the cell primarily due to the flow of the gas. Because channels extend laterally across the faces of bipolar plate 78, gravity typically causes water to accumulate in the channels in the absence of gas flow. Thus, sufficient gas flow through a cell stack having a horizontally-oriented bipolar plate 78 provides for the removal of water from bipolar plate 78 and the cell stack.

Referring now to FIG. 6, both the anode side and the cathode side of bipolar plate 78 can be seen. Channels 96 on the cathode side of bipolar plate 78 and the channels on the anode side of bipolar plate 78 (shown at 102) are typically rectilinear in cross sectional geometry, although other geometries, for example, semi-circular configurations, V-shaped configurations, and the like, are possible. Edges of bipolar plate 78 along the length are also removed to provide cut-out sections 108 that define fins 110 that extend along the length of bipolar plate 78. When a plurality of bipolar plates 78 are assembled to form the cell stack, fins 110 provide means by which heat can be conducted from the inner regions of bipolar plate 78 (proximate channels 96, 102) and allowed to radiate to the surrounding environment. Because the length of bipolar plate 78 is substantially longer than wide, fins 110 account for most of the edges of bipolar plate 110, thereby providing a large surface area from which heat can be removed. Bipolar plates that define the end plates of the cell stack are substantially similar to the plates that comprise the body of the fuel cell stack. Such bipolar plates, however, include channels disposed only at a functional side of plate.

Referring back to FIG. 3, the components of the cell stack are maintained in alignment by alignment pins 111 extending from manifold 84, through holes disposed in the ends of MEAs 76, bipolar plates 78, and base plate 82 and to a support plate (e.g., a spring support plate 124 and an end plate 112). MEAs 76 and bipolar plates 78 are held in a stack arrangement by being compressed between base plate 82 and an inner surface of manifold 84. Side plates 122 extend between spring support plate 124 and manifold 84 to provide rigidity to the stack structure and are attached to spring support plate 124 and manifold 84 via the engagement of tabs 126 with holes 128 disposed proximate the opposing edge surfaces of side plates 122. Spring support plate 124, manifold 84, and side plates 122 are dimensioned such that, when assembled, the resulting structure substantially corresponds in length and width to the cells.

The compression of plurality of cells 72 is effected in the direction normal to the direction in which the plane of the cells extend by the biasing of base plate 82 against the stack structure, which is in turn biased against manifold 84. Base plate 82 is removably positioned between bipolar plate 78 and spring support plate 124 so as to be in a parallel planar relationship. The compression is effected by resilient members 80, which may be, for example, urethane springs mounted on pins 130 extending normally from the facing surfaces of base plate 82 to spring support plate 124. Other types of resilient members that may be used include, but are not limited to, Belleville washers mounted on pins 130.

Space may be defined between side plates 122 and the edges of plurality of cells 72. The fins protruding longitudinally along the lengths of each bipolar plate 78 generally extend into such space. In order to provide further cooling of the cell stack, an air stream may be passed through the space between the outer edges of the fins and the inner faces of side plates 122 to convectively remove heat generated during the operation of the cell stack.

Although an electrochemical cell operated as a fuel cell generates water at the cathode, the air introduced to the cathode is preferably humidified to prevent drying of the entrance region of the fuel cell flow field. The amount of water generated at the cathode is generally sufficient to humidify the inlet air and keep it saturated as it passes from the entrance region of the flow field to the cathode. In order to utilize the generated water for humidification of the air, the water is removed from the cathode of each cell and returned to manifold 84. Once returned to manifold 84, the water can be sprayed through an atomizer into the incoming air stream to saturate the air.

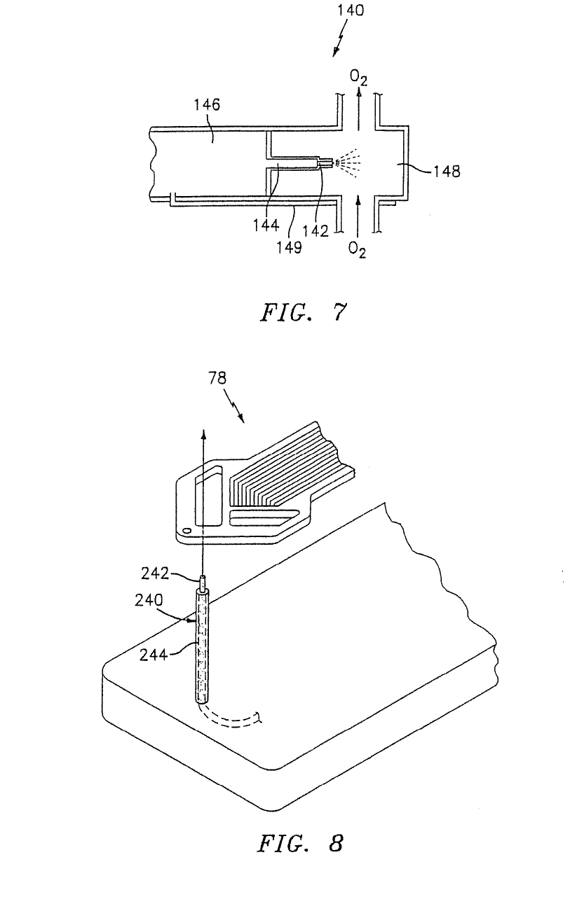

Referring now to FIG. 7, the atomizer for the electrochemical cell operated as a fuel cell is shown at 140. Atomizer 140 comprises a spray nozzle 142 and a water return line 144 disposed in fluid communication with spray nozzle 142. Water return line 144 receives the water generated at each cathode of the cell from a cathode outlet 146 and feeds it through spray nozzle 142 to humidify the air as it passes through an air inlet 148. Preferably, the rate of water sprayed is metered and regulated such that a minimum amount of liquid water is removed from the cell. Any excess water that is sprayed, however, may be returned to cathode outlet 146 via an overflow duct 149 that extends between air inlet 148 and cathode outlet 146.

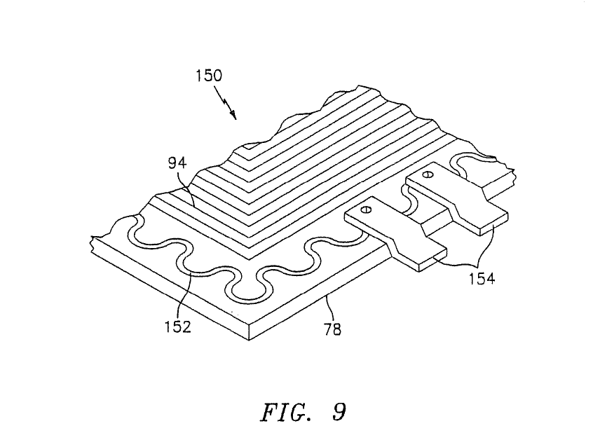

In another exemplary embodiment of the cell stack shown in FIG. 8, an atomizer 240 may be configured as an alignment pin located at an edge of manifold 84. The alignment pin is preferably a rigid structure extending in the direction normal to the stack of bipolar plates 78 to provide a directional assembly of bipolar plates 78. A water return line 244 is defined by the hollow core of the alignment pin, and a spray nozzle 242 provides a water spray at the open port areas intermediate the cells to humidify the air as it passes from water return line 244 to each cell. Because the alignment pin is preferably rigid, bipolar plates 78 are maintained in alignment within the cell stack.

Referring to both FIGS. 7 and 8, because the air supplied to the fuel cell is saturated by atomizer 140 at a temperature significantly less than the operating temperature of the fuel cell, the cell is operated within a prescribed envelope defined by temperatures, pressures, and flow rates. For example, in one exemplary embodiment, the fuel cell is operated at about 55° C. to about 85° C., the pressure is maintained up to about 30 pounds per square inch (psi) (206.8 kPa (kilo Pascals)), and the stoichiometric ratio of air to hydrogen is about one to about three. The spraying of the inlet air with atomized water at a temperature of about 55° C. to about 85° C. facilitates the heating of the inlet air.

If the electrochemical cell is operated as a fuel cell, the cell stack may further comprise a heater to maintain the thermal integrity of the cell stack and its ability to start rapidly with minimum warm-up time when cold. One exemplary embodiment of the heater disposed on a bipolar plate 78 is shown at 150 with reference to FIG. 9. Heater 150 comprises a heater element 152 disposed at the surface of bipolar plate 78 between an edge of bipolar plate 78 and flow region 94. When the cell stack is assembled, heater element 152 is disposed in contact with an adjacently positioned bipolar plate (not shown). Heater element 152 is disposed in electrical communication with an electrical source (not shown) through leads 154, which supply electrical current to heater element 152.

In one exemplary embodiment of heater 150, heater element 152 comprises an electrically resistive material deposited onto the surface of bipolar plate 78. The electrically resistive material may be deposited onto the surface of bipolar plate 78 in any one of or a combination of a variety of manners including, but not limited to, sputtering, chemical vapor deposition, stenciling, screen printing, painting, and the like. Thicker depositions of the electrically resistive material are generally sputtered or deposited using vapor deposition techniques. For example, the metal is formed into a paste, screen printed onto the surface of bipolar plate 78, and dried. The metal may be combined with a binder, cellulose, and a solvent to make the paste. The paste is preferably applied to the surface of bipolar plate 78, dried, and sintered onto bipolar plate 78. Heater element 152 may be deposited in a wave pattern, as is shown, or in any other pattern.

A plurality of heater elements 152 may be incorporated into the architecture of the electrochemical cell. In particular, heater elements 152 may be disposed at least one bipolar plate in order to provide optimum heating to the cell stack and to minimize the warm-up time prior to starting the fuel cell. Heater elements 152 are generally maintained in electrical communication with each other through a wiring harness.

The electrochemical stack design described above provides superior functionality of an electrochemical cell. The shape of the flow field facilitates the dissipation of heat from the edges of the flow field members and radiation of the heat outward from the cell. Convective airflow along the edges of the flow field members further enhances the efficiency of the heat removal. By effectively removing the heat, the life of the cell can be prolonged beyond the life of a conventional cell. The design further allows for the removal of latent heat via the water stream from the cathode. Heat removal via a combination of the water stream and airflow enables the electrochemical cell to be operated with fewer plates.

Because the cell stack includes the stacked plates maintained in alignment by side plates, misalignment of the MEAs with respect to the plates is minimized. Furthermore, because of the dimensions of the plates, a cell stack can be constructed from fewer plates than a fuel cell having the same output and power requirements, which translates into fewer pieces for assembly and service. Compression of the plates is also improved, in that multiple compression devices (e.g., Belleville washers or urethane springs) exerting pressure against a common element (e.g., the base plate) tend to provide more uniform compression over a greater area than conventional compression devices for cell stacks.

Furthermore, by minimizing the angle at which the channels extend over the bipolar plates, a substantially linear path for the flow of reactant gases and the removal of water is effected. Such a substantially linear path minimizes the probability of fluid holdup in the channels, which also minimizes the amount of phase separation of the humidified reactant gases in the bipolar plates, further contributing to effective heat removal.

By recycling the water stream from the cathode to humidify at least one of the reactant feed streams, the need for introducing a separate humidification stream is reduced, which, in turn reduces the amount of cell inputs. Use of the water stream as a humidification stream further reduces the by-product output of the cell and promotes a more self-contained and self-sufficient aspect of fuel cell technology.

Heating of the cell stack by inserting heaters between adjacently-positioned bipolar plates allows for the rapid startup of the fuel cell when the ambient temperature is markedly less than the temperature at which the fuel cell normally operates. Because the time for a resistive heater to reach its rated temperature is generally quick, such heaters are generally superior in performance compared to systems in which coolant return streams are used to provide heat. Because of their ability to be screen printed or otherwise deposited onto surfaces, resistive heaters may be employed in places and in configurations (e.g., disposed between adjacently-positioned bipolar plates) that conventional heaters cannot be employed.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A compression device, comprising:
a base plate having a surface;
a spring support plate;
a resilient member disposed between the spring support plate and the base plate in compressible mechanical communication with the base plate to impart a force to the base plate in a direction normal to the surface;
a manifold disposed on a side of the base plate opposite the spring support plate; and
a side plate disposed from the spring support plate to the manifold, wherein the side plate physically engages a periphery of the manifold and a periphery of the spring support plate;
wherein the device is capable of compressing a cell stack between the base plate and the manifold.

2. The device of claim 1, wherein the side plate has openings, and the manifold and spring support plate have tabs disposed in the openings.

3. The device of claim 1, wherein the resilient member is an urethane spring.

4. The device of claim 1, wherein the resilient member is a Belleville washer.

5. The device of claim 1, wherein the spring support plate and the manifold are disposed in a parallel planar relationship.

6. An electrochemical cell device, comprising:
a cell stack comprising cells, wherein each cell comprises a first electrode and a second electrode with a membrane disposed therebetween;
a compression device comprising
a base plate having a surface;
a spring support plate;
a resilient member disposed between the spring support plate and the base plate in compressible mechanical communication with the base plate to impart a force to the base plate in a direction normal to the surface;
a manifold disposed on a side of the base plate opposite the spring support plate; and
a side plate disposed from the spring support plate to the manifold, wherein the side plate physically engages a periphery of the manifold and a periphery of the spring support plate;
wherein cell stack is compressed between the base plate and the manifold.

7. The device of claim 6, wherein the side plate has openings, and the manifold and spring support plate have tabs disposed in the openings.

8. The device of claim 6, wherein the resilient member is an urethane spring.

9. The device of claim 6, wherein the resilient member is a Belleville washer.

10. An electrochemical cell device, comprising:
a cell stack comprising cells, wherein each cell comprises a first electrode and a second electrode with a membrane disposed therebetween;
a base plate disposed at the cell stack;
a spring support plate disposed on a side of the base plate opposite the cell stack;
a resilient member disposed between the spring support plate and the base plate in compressible mechanical communication with the base plate;
a manifold disposed on a side of the cell stack opposite the base plate, and disposed in a parallel planar relationship with the spring support plate, wherein the manifold has manifold tabs disposed at a periphery of the manifold; and
side plates disposed from the spring support plate to the manifold, wherein the side plates engage the manifold tabs and the support tabs;
wherein cell stack is compressed between the base plate and the manifold by compressive force applied by the resilient member in a direction normal to a plane defined by a length and a width of the base plate.

11. The device of claim 10, wherein the side plate has openings, and the manifold and spring support plate have tabs disposed in the openings.

12. The device of claim 10, wherein the resilient member is an urethane spring.

13. The device of claim 10, wherein the resilient member is a Belleville washer.
